(19) United States
(12) Patent Application Publication
(10) Pub. No.: US 2007/0022377 A1
(43) Pub. Date: Jan. 25, 2007

(54) Method for optimizing the implementation of measurements with medical imaging and/or examination apparatus

(76) Inventors: Sultan Haider, Erlangen (DE); Ernst Bartsch, Nurnberg (DE)

Correspondence Address: SCHIFF HARDIN, LLP;PATENT DEPARTMENT, 6600 SEARS TOWER, CHICAGO, IL, 60606-6473, US

(21) Appl. No.: 11/490,157

(22) Filed: Jul. 19, 2006

(30) Foreign Application Priority Data
Jul. 21, 2005 (DE) 10 2005 034 160.8

(51) Int. Cl. G06F 17/00

(52) U.S. Cl. 715/707

(57) ABSTRACT

A method and apparatus for optimizing the implementation of measurements with at least one imaging medical examination apparatus, includes the followings steps: determination by a user executing a measurement of an existing first item of measurement-related information given a program means-based measurement, which information is in the form of an employed item of measurement parameter information, and determination of at least one associated further item of measurement-related information (in particular established by the user), and storage of said information in a storage device via a data processing system (S1); determination of at least one item of information identifying the user executing the measurement and storage of said item of information with the measurement-related information in the storage device (S2); linking, via the data processing system, of the measurement parameter information and at least one further item of measurement-related information dependent on the information identifying the user (S3); and user-specific adaptation of a user interface provided for operation of the program means dependent on the link result (S4).

### BACKGROUND OF THE INVENTION

1. Field of the Invention

The present invention relates generally to a method for optimization of the implementation of measurements with at least one imaging medical examination apparatus.

2. Description of the Related Art

For a user to implement of measurements with imaging medical examination apparatuses (such as, for example, magnetic resonance apparatuses, computer tomography apparatuses and the like), the user must have a comprehensive knowledge of how to implement the measurement such that the measurement can be used to generate a well-founded diagnosis or to further plan a course of treatment for subsequent implementation. Due to the immense number of items of measurement information (such as parameters for acquiring image data with the medical examination apparatus and the further processing of the image data) that play a role in the measurement, for example with a magnetic resonance apparatus and, if applicable. are input or adapted by the technician or doctor executing the examination, the implementation of measurements turns out to be time-consuming, expensive and error-prone. For example, the user may easily overlook that a specific measurement parameter has an incorrect value . or the necessity of adapting a parameter for the particular measurement may be unclear to the user from the start.

The testing of new sequences or new measurement systems that are to be used for implementing measurements proves to be similarly problematic since there are also a number of parameters and f further measurement information that must be considered for specifying the measurements.

The user who will be performing the measurement with the aid of a program that is provided for performing the measurement is confronted with the problem that, even in the case where specific measurement information is provided, for example by a default protocol, the information contained in the protocol that corresponds to the measurement and that is to be input into the measurement apparatus are normally not all necessary or are not all to be changed for his measurement. On the other hand, the possibility exists that measurement information that the user would like to change for the measurement procedure are not accessible as a result of the protocol, or the measurement information is only accessible after the user expends a certain effort via a user interface of the program.

### SUMMARY OF THE INVENTION

The present invention provides a method for optimizing the implementation of measurements with at least one imaging medical examination apparatus. The present method includes the steps of: determining by a user executing a measurement of an existing first item of measurement-related information given a program means-based measurement, which information is in the form of an employed item of measurement parameter information, and determining at least one associated f further item of measurement-related information (in particular established by the user), and storing the information in a storage device via a data processing system; determining at least one item of information identifying or characterizing the user executing the measurement and storing the item of information with the measurement-related information in the storage device; linking, via the data processing system, of the measurement parameter information and at least one f further item of measurement-related information dependent on the information identifying the user; and providing a user-specific adaptation of a user interface provided for operation of the program dependent on the link result.

Furthermore, the invention concerns a device for optimization of the implementation of measurements with imaging medical examination apparatuses, which device is fashioned for implementation of the method according to the preceding.

### BRIEF DESCRIPTION OF THE DRAWINGS

FIG. 1 is a workflow diagram showing an embodiment of the method according to the principles of the present invention;

FIG. 2 is a functional block diagram showing a user-specific adaptation of a user interface according to the present method;

FIG. 3 is a schematic drawing showing the association of a user with a class of users; and

FIG. 4 is a functional block diagram of a system using the present method.

### DETAILED DESCRIPTION OF THE PREFERRED EMBODIMENTS

According to the present method, a first step of the method is to initially determine an item of measurement-related information given measurements with imaging medical examination apparatuses such as, for example, magnetic resonance apparatuses, computer tomography apparatuses, apparatuses for implementation of positron emission tomography or ultrasound apparatuses, and the like. This determination ensues via a data processing system, which is to be understood in the broadest sense and includes in one example is realized with various server and client computers that are connected with one another over a network. The method provides that at least one further item of measurement- related information is determined. A determination of the measurement information is performed using the Internet or an intranet, for example.

The determination can ensue such that all of the data or only a specific, previously-selected number of data items in the form of measurement-related information are provided by a user given each of the measurements or only for some of the measurements. For this determination, the data is transferred (if applicable) over a network either before or also after a measurement. However, the user preferably makes a decision about the transmission of the measurement-related information for storage via a data processing system, for example in that the user explicitly releases these or limits the transmission or storage to a limited number of items of information in order to thus exclude very anomalous items of measurement-related information or measurement-related information leading to unsatisfactory results from usage in the framework of the optimization of the implementation of measurements. The determination of information can, for example, be based on service networks via which manufacturers of examination apparatuses obtain data of the devices operating in different medical apparatuses. Furthermore, research networks can be used.

Furthermore, at least one item of information is determined that identifies the user executing the measurement (such as, for example, a technician or medical-technical assistant or scientist active in the field of research) that is stored in the storage device together with the measurement-related information, of which at least one item is an item of measurement parameter information. In addition to the measurement-related information, an item of user-specific information thus exists that enables specific conclusions to be made about the user as a user of this measurement-related information. In the simplest case, the information identify the user is merely the name or, respectively, a login of this specific user; however, it can additionally or alternatively be further information such as the field of activity, the association with a specific research facility or clinical facility or the education or training level of the user. This information can. for example, be determined in that a user inputs a login and/or a password (the is specific to the user) via the program or other program means before the execution of measurements, or in that the measurement information is transferred such that it is provided with program-specific supplementary information that also concerns the utilization of the measurement and that, for example, is known from the registration of the program.

The at least one item of measurement parameter information is subsequently linked with at least one further item of measurement-related information, whereby the linking step ensues depending on the information identifying the user. In the simplest case, the linking step can simply ensue by establishing a connection between different data in that the one or more items of measurement parameter information and the at least one further item of measurement-related information (which can naturally in turn be an item of measurement parameter information) are stored such that the relation between them is clear. For this, databanks or databases can be referred to that enable a structured storage of data. The linking step can include further steps, in particular when more than two items of measurement-related information are connected with one another. In this case, for example, a hierarchy between the individual items of information can be set in particular or a conditional dependency of the one item of information on one or more further items of information can be taken into account. Furthermore, it is possible to implement a linking of the information such that the result is weighted or probabilities of individual measurement-related information are incorporated into the link result.

The user interface that is provided for operation of the program, for example a user interface shown on a screen, is subsequently adapted dependent on the link result and in a way that is specific to the user. This preferably occurs continuously or after implementation of a specific number of measurements by this user or by a number of implementations by a different user who is related to the first user with regard to the information identifying the user. Generally, only after a certain number of measurements have been implemented are a sufficient number of items of information present for optimization of the user interface. The number of such measurements is not limited, but is dependent on the circumstances. Optimization can be ensured, for example, by utilization of thousands of measurements that are implemented with great regularity with systems that are in worldwide distribution.

With the inventive method it is thus possible to structure measurement-related information that, if applicable, are already determined in the framework of existing information systems or, respectively, service systems and the like such that the measurement implementation can occur in an optimized manner. For this, the user interface is adapted to the respective user such that a fast measurement implementation tailored to the user's requirements is possible regardless of the numerous items of measurement-related information (such as, for example, measurement parameter information) available. In contrast to conventional optimization methods, the requirements of specific users or groups of users are thereby applied. For example, the user interface is thus specifically adapted for users in different countries or even for users in different facilities that either primarily examine these particular measurement questions or that only perform such measurements infrequently as the result of working, for example, in different examination fields. The actual items of measurement-related information that play a role for these users form the foundation of this adaptation. The workflow can thus be distinctly improved when performing image acquisition with imaging medical examination apparatuses, and the numerous items of measurement-related information available for a determination are stored in a structured form so that the information may be used for optimization.

According to the invention, further items of measurement parameter information and/or processing information regarding data of the measurement can be determined as further measurement-related information. A user can thus, for example, send all measurement parameter information or only a specific selection of measurement parameter information (for example for a partial range of the measurement) via the data processing system for storage.

Using the data processing system, the measurement parameter information is determined and, if applicable, is linked with one item or with further items of measurement parameter information or, alternatively or additionally, with processing information regarding the data of the measurement. The processing information concerns the further processing of the data that has been acquired or which is to be acquired in the measurement or in the preparation of the processing information. For example, processing information of images and/or of image series selected on the part of the user can be a measurement or a series of measurements or parameters specified for the representation of specific images or image series. for example for the size or arrangement of the images. Furthermore, specifics regarding technical features of the images (such as resolution or contrast) or regarding a desired image representation, (for example with regard to a specific anatomical orientation) are considered part of the processing information. Processing information in the sense of further measurement-related information can furthermore be findings that are input by the. user regarding measurements or any pathological changes that a user inputs or that are discovered by means of a corresponding image processing system. The processing information preferably includes anatomical orientation information for a desired or already-implemented measurement, for example.the specification that views of an examination region such as the head are to be seen in a sagittal section in an image series, as are specifics regarding the underlying examination region, for example whether a whole-body measurement or a measurement in the torso region was implemented.

Many items of information (such as specifics regarding the orientation of a possibly-generated prescan, of a region shown in an image as well as regarding adaptations of absorption data and the like) can thus be drawn upon in relation to specific anatomies for the optimization of the measurement implementation.

Moreover, depending on the link result at least one protocol that is selectable via the user interface by a user (in particular a measurement protocol and/or processing protocol) can be adapted and/or executed. The user interface is thus effectively adapted for a specific user who, for example, belongs to a group of users regarding for numerous items of measurement information exist, in that a protocol based on information of the group and possible additional information of only this user is provided to this user. Frequently-occurring measurements can be directly implemented on the part of this user by only providing this one protocol (or possibly by providing multiple protocols), and furthermore the processing, like the further evaluation of the acquired image data, can be largely or completely provided and inasmuch automated. The evaluation via a predetermined processing protocol is therewith virtually simulated without intervention of the user, depending on which desired representation of images and the like can be derived from the present items of measurement information dependent on their linking.

According to preferred embodiments of the invention, in a further measurement (in particular in the framework of a subsequent or follow-up examination) at least one item of measurement parameter information and preferably several items of measurement-related information can be determined and linked with the measurement-related information of the first measurement for adaptation of the user interface. By this continuous linking that is implemented for a larger number of measurements, it is possible to track the connection of measurement-related information (such as measurement parameter information) with further measurement-related information over a specific time period and for different measurements, and possibly for different users, in order to thus determine variations of this connection or trends with regard to the mutual occurrence of measurement parameter information and specific further measurement-related information. The user interface can thereby be improved further and further for an individual user do to the existence of a larger number of measurements taken in similar facilities or even in the same region or the same country for similar questions, such that the time for implementation of measurements and the incurred costs can be further reduced.

Furthermore, according to the preferred embodiment of the invention it is possible that further items of measurement-related information are linked with one another and/or protocols (in particular the measurement protocols and/or processing protocols) are linked with one another for adapting the user interface. The user interface can therewith be further improved; information, for example information regarding the connection of specific findings with a desired image representation in the framework of the image evaluation, is thus incorporated into the adaptation of the user interface independent of the measurement parameter data. The user interface can therewith be further refined beyond the consideration of the measurement parameter information, in particular after a plurality of measurements (such as, for example, of multiple thousands of measurements with a specific imaging examination apparatus). In a further refinement, for example, the input of a suspicious diagnosis by the user is sufficient that it triggers a matching evaluation protocol to run automatically for the processing.

In the preferred examples of the method, the user interface can be adapted by specifying at least one item of measurement parameter information and/or further measurement-related information. The user thus obtains his or her own interface for the program allowing the measurement implementation (possibly after logging in or the specification of an examination field), in which interface at least one measurement parameter (normally a certain number of measurement parameters) is already provided with its values, whereby the predetermined values correspond to the values to be expected using the previously-determined measurement-related information. For example, the orientation for an image acquisition and the thickness for the corresponding slices of the image exposure can thus be predetermined, where the orientation and thickness correspond to an average value or to a frequently-used value of this user or of an associated group of users, for example in a specific facility or a specific region or country. Naturally, the user can change the values from the predetermined values when desired, but for inexperienced users it is possible to disable the ability to change the predetermined values or at least make changing them more difficult. Further measurement-related information (such as a first diagnosis by the data processing system after an evaluation of the acquired images, or a designation of an examination region for a first measurement, or a suggestion for a further measurement) can likewise be provided.

The specification of the measurement parameters can be used in a subsequent measurement, in particular given a subsequent measurement after determination of at least one overview image and/or given a repetition of a measurement. Measurement-related information or, respectively, measurement parameters for follow-up examinations can thus be predicted based on the input or on the implementation of, for example, a first scan or the image processing selected for the first data in order to make the continuation or repetition of a measurement easier.

Furthermore, the user interface can be adapted by changing the hierarchy for selection and/or input of protocols, and/or for selection and/or input of measurement parameter information. and/or by changing and/or limiting the protocols and/or measurement parameter information that can be selected and/or input. For example, the hierarchy for selection or input of protocols or measurement parameter. information is varied in that, for example, initially the retrieval of a specific application page that allows a variation is required to find the input possibilities for parameters that are seldom changed in a small medical facility of a specific user. The representation that the user initially receives is thus only provided with the most likely necessary input and selection possibilities in order to not confuse or, respectively, overtax the user with the representation of too many change possibilities. On the other hand, for example, additional protocols can be provided via the user interface in addition to a previously-available default protocol, which additional protocols better correspond to the conditions of the immediate user implementing a measurement.

In the framework of adapting the user interface, measurement-related information for selection and/or changing the interface can be shown organized by user. The representation is thus structured specific to the user, for example via the preceding description or emphasizing frequently-changed parameters and the like.

The measurement parameter information and/or the one or more items of further measurement-related information and/or the link result or link results can be stored in a databank or database. A fast search and consequently a fast discovery of information is also possible through the use of a suitable administration system. As a result of the structured storage in the database, which can also be a system of databases, a linkage between the existing information can be quickly established through the usage of typical database structures such as tables.

Newly arriving measurement parameter information of a user whois to be associated with, for example, a specific user group of doctors working in research can thus be directly associated with the other data that is already present regarding this user or this user group.

At least one new item of measurement-related information that is being stored in the database can be linked with at least one already-present item of measurement-related information and/or f further data of the database and/or be used for updating the database. A newly-arriving measurement parameter with identi fing information that matches the user can thus be compared with earlier measurement parameter information used by this user in order to establish a correlation via a comparison in the framework of this link.

If a correlation exists, this measurement parameter alone or with a f further item of measurement-related information is furthermore employed by the user. Previously unselected measurement-related information or, respectively, measurement-related information that was not previously present for this user can be used to update the database with regard to the associated user group or can be linked with further data with regard to the selection of information for specific examinations by specific users or the like. New information can be used to update the database, for example in particular when the new information is newly-arriving information that replaces older information, such that the older stored measurement information is then deleted or is no longer used for adapting the user interface.

On the part of the data processing system, probabilities can be determined for stored measurement-related information and link results and/or a plausibility check can be implemented. For example, it can thus be detected . for a specific user that, given an input of a specific item of measurement parameter information, a further number of parameters or items of processing information can be expected with a high probability that they will have an equal value for each measurement or have a value lying in a specific range. In this case, a user interface can be provided to the user with the information already specified and with a certain probability that this is the information that the user will select. Furthermore, a plausibility check can be performed as to whether there is a concurrence of different measurement-related information or of link results implemented in the framework of one measurement or a further similar measurement, so that a check is performed as to the plausibility, for example, to decided whether the newly-input information should to be stored at all or whether the link results will reasonably be used or not for adapting the user interface.

Depending on measurement-related information and/or link results, the user can be associated with a class of users. This allows a better optimization since, given such a classification or arrangement into user groups, a user-specific adaptation of the user interface with reference to the information present for the corresponding user class is possible even for users who merely conduct a few (and thereby different) measurements. Users can thus be classified with regard to the imaging examination apparatus at which they conduct measurements, with regard to the preferred examination types, and with regard to the facilities in which they work (whether they are, for example, research facilities or smaller clinics) and the like. A user can naturally be associated with a plurality of classes that are possibly hierarchically organized in order to achieve a further optimization of the measurement implementation. For example, a class of doctors that are scientifically active in the field of magnetic resonance apparatuses in a specific country can be considered as one class.

Furthermore, it is inventively provided that measurement information of a user and/or of a class of users is stored in a data field. This data field is then available in machine-readable form for the automatic linking by the data processing system. Examples for entries into the data field comprise the respective imaging examination apparatus, an examination type, a specific number of the measurement, items of measurement parameter information that, for their part, can be sub-divided into possible options and subordinate options as well as further field entries, whereby the first measurement can be identified for the user or, respectively, the user group with an index that can be incremented given subsequent examinations or measurements in connection with an updating of the measurement-related information. The user can thus be classified as a standard user or advanced user and the like after the user has conducted a specific number of measurements.

Measurement-related information, in particular measurement parameter information, can be stored in a file that is adapted given changes of information by the user. A log file with all possible measurement parameter information can thus be generated in which an incrementing step if performed in the case of a variation or a usage of a specific measurement parameter, if applicable given an associated option or sub-option. For example, for a specific examination region or an examination type the number of the implemented measurements with the corresponding other parameters is thus registered in a form is simple to process by the data processing system.

At least one learning-capable and/or knowledge-based system can be used for adaptation of the user interface. For example, an expert system or rule system in which medical knowledge as well as knowledge regarding the technical requirements of specific imaging examination apparatuses or connections between measurement parameters or, respectively, items of information of a subsequent evaluation of the acquired images is stored can be drawn upon in order to determine and to specify specifications for measurement-related information in the user interface, if applicable after the presence of further input information. The adaptation of the user interface can furthermore ensue via systems that are in the position for adaptive learning, whereby learning what is an optimal user interface occurs depending on the preferences of a specific user and possibly on further existing knowledge and current user specifications. Neural networks, adaptive filters, genetic algorithms, training . as well as Bayes techniques for data prediction and the like can be resorted to in this context.

The data processing system can furthermore exchange data with at least one existing information system, in particular with an information system of a medical facility and/or a class of users. This information which, for example, exists in a clinic-specific information system or in an information system for radiologists or scientists in the medical field can likewise be incorporated into the adaptation of the user interface. The information systems and the data storage in the preferred method can thereby be organized across a communication databank system.

The user can define the determination of measurement information and/or the link results and/or the specification of measurement information, in particular in the framework of a protocol. The user can hereby preferably specify which prior knowledge (for example present in a databank) or also which knowledge-based system should be used with which parameters. In this context, the user can, for example, specify the selection of specific strategies for fitting the data or specify the selection of representation parameters or even algebraic expressions for parameters.

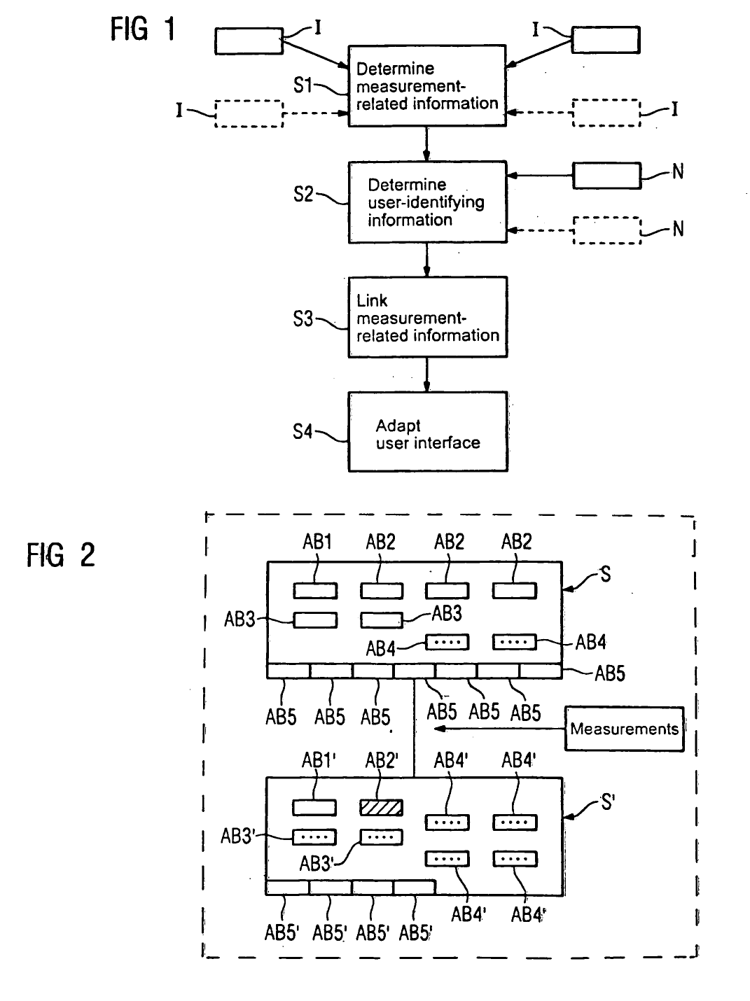

With reference to the drawings, FIG. 1 shows a workflow drawing of a method according to the present invention. In a first step S1, measurement-related information I is initially determined in the framework of the optimization of a user interface for the operation of an imaging medical examination apparatus. This measurement-related information or measurement information is determined with the aid of a data processing system using inputs that a user executing a measurement makes on a program provided for implementing the measurements.

At least one item of first measurement-related information I in the form of utilized measurement parameter information and at least one associated further item of information I (such as a further parameter or, respectively, processing information) are determined in the present example. Furthermore, other items of measurement-related information I may be optionally and additionally determined are indicated in FIG. 1 by dashed boxes with the dashed arrows. The measurement-related information I is stored in a storage device.

Further, in a step S2 at least one item of information N that identifies the user that is executing the measurement is determined, if applicable with one or more further optional items of information N identifying the user, as is in turn indicated by the dashed box with the associated arrow. The information identifying the user that is, for example in the form of a login or in the form of information regarding the field of activity or, respectively, the facility in which the user is active, is stored in the storage device with the measurement- related information I.

The item of measurement-related information I that is in the form of measurement parameter information and at least one further item of measurement-related information I are linked by the data processing system in a step S3, dependenting on the at least one item of information N identifying the user, in that a connection between both of these items of measurement-related information I is established by consideration of the associated user with regard to the information N related to the user. Probabilities are or, respectively, the plausibility is calculated or checked for the link result by considering f further present items of measurement-related information I as well as information N identifying the executing user.

Finally, an adaptation of the user interface specific to the user occurs in the step S4 for the respective user or for his user group, dependent on the link result. This adaptation, for which the determined probabilities and plausibilities are taken into account given the existence of a larger number of measurement-related information I, exists in that specific measurement-related information I are already provided in the user interface or seldom-changed measurement-related information I can only be changed after clicking on a selection field of the user interface regarding this. Furthermore, protocols for the measurement and a subsequent processing are provided in the framework of the user-specific adaptation of the interface for specific examinations or diagnoses to be clarified.

According to the invention, an optimization of the user interface is thus achieved by considering the underlying protocols that take into account the peculiarities of different users in the research or clinical field or also in facilities in different regions or countries.

FIG. 2 shows a user-specific adaptation of a user interface S in the present method. The user interface S allows the operation of the program by a user for implementation of measurements with imaging medical examination apparatuses. For this, the user interface S has a specific page for the input and alteration of measurement-related information to be used for the examination. The input and alteration of the information is enabled for the user only in specific selection fields AB 1 through AB 5 after the user has registered as a user for the implementation of measurements with the examination apparatus.

The different selection regions AB 1 through AB 5 are provided for the input or selection of a specific group of items of measurement-related information (such as, for example a group of specific items of measurement parameter information) between which a connection exists for the measurement implementation or, respectively, generally for a range of measurement-related information regarding which further items of sub-information or, respectively, sub-options exist in the form of the individual boxes of the selection regions AB 1 through AB 5.

In the illustrated case, the user interface S initially comprises a selection region AB 1 with a box for selection or, respectively, input of the respective measurement-related information, a further selection region AB 2 with three associated boxes as well as two further selection regions AB 3 and AB 4 with two respective boxes serving for the input or, respectively, selection of the corresponding information regarding the. implementation of the measurement.

The selection region AB 5 comprises a plurality of boxes that refer to the rough classification or organization of the underlying program that allows respective inputs regarding the examination routine, regarding the resolution, regarding the geometry, regarding the system, and the like.

With the implementation of measurements by the user, using a data processing system (shown schematically in dotted outline) measurement-related information is determined that is used (after a corresponding evaluation in the framework of a linking of+ items of information identifying the user) for user-specific adaptation of the user interface S, which user interface switches over in the following to the user interface designated with S′. No change has occurred in the selection region henceforth designated with AB 1 ′, while an adaptation with regard to the link results acquired from a plurality of measurements by this user and f further users has occurred in the remaining selection regions AB 2′ and AB5′. For example, the individual boxes of the selection region AB 2 of the user interface S have thus been replaced by the selection region AB 2′, which is initially to be clicked on via the single box and is to be selected in order to obtain the individual input possibilities of the earlier selection region AB 2. The items of information of this selection region AB 2′ that are not altered by the user are thus normally combined or merged and recessed or relocated in the hierarchy of the ′user interface S′ via the indirect selection.

By contrast, in comparison to the previous selection region AB 4 the selection region AB 4′ has been expanded by the addition of further boxes while a specification (indicated by points) of entries with regard to values frequently selected by the user now occurs in the selection region AB 3′. The number of boxes available to the user in the selection region AB 5′is likewise reduced.

A user interface S′ has been created according to an embodiment of the invention that is better adapted to the requirements of the respective user in that the parameters and further measurement-related information that this user frequently changes are directly accessible on the interface while such measurement-related information that are only seldom-changed by the user are presented on the interface so that the information cannot be directly altered in the user interface S′ or are not directly shown.

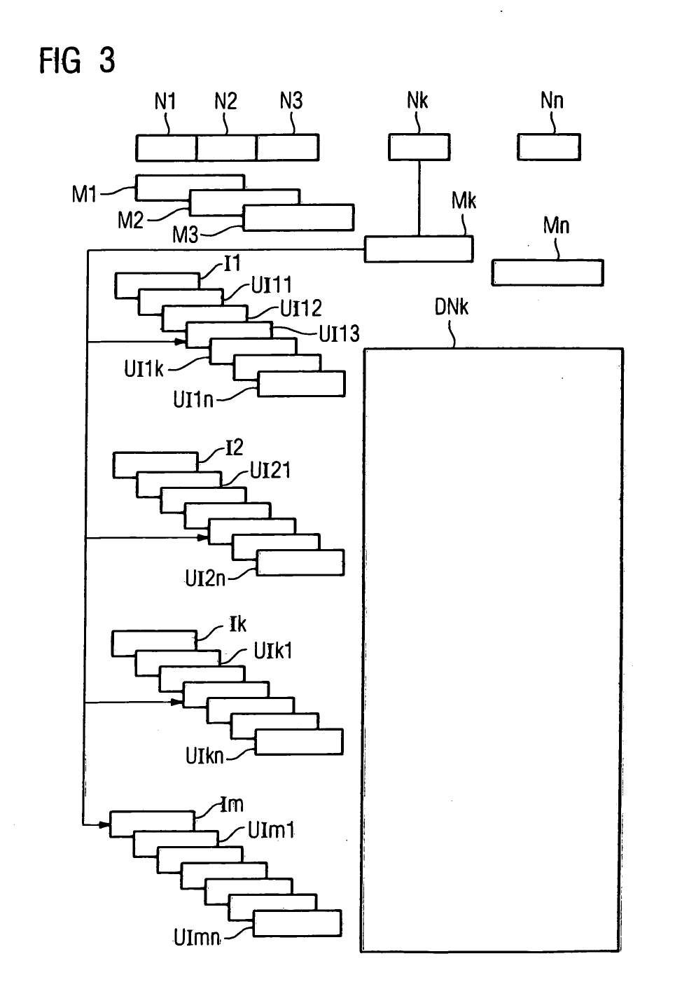

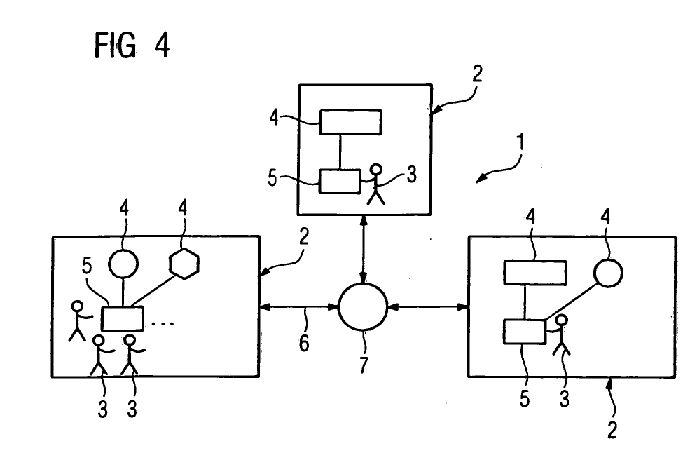

FIG. 3 shows a drawing illustrating the association of a user with a class of users. Different users NI through Nn for the determination of information in the framework are initially provided for the determination of information in the framework of the inventive method for optimization of the implementation of measurements. Furthermore, there are different measurements M1 through Mn that correspond to different examination types which, can be conducted by the different users N1 through Nn or a specific number of users N1, N2, . . . with imaging medical examination apparatuses.

With regard to a specific measurement Mk that is conducted by a user Nk, different items of measurement-related information 11, 12, . . . ,Im with which a series of items of sub-information U111, U122, . . . are possibly associated are available to the user Nk. All of these items of measurement-related information 1 or, respectively, U1, which can be understood as options and association sub-options, are selected by the user or, respectively, a specific value for an associated measurement parameter and the like is predetermined. After their determination, the items of measurement-related information are stored in a user-specific file DNk for the user Nk, which file DNk lists the measurement-related information in the form of a data field for the individual measurements M1, M2, . . . corresponding to different examination types, the individual measurements and associated information 1 as well as sub-information U1.

In the file DNk, the selection of specific information 1 or, respectively, U1 or, respectively, the selection of specific values of the information 1 or, respectively, U1 (such as, for example, the implementation of measurements of a specific examination type M1) are updated given a subsequent examination in that an associated index for the number of implemented measurements or also the frequency of the selection of a parameter value is incremented. Further items of information 1 or, respectively, U1, in particular such items of information that are not selected but rather are freely input, are likewise appropriately directly stored with their respective values in the file DNk. A classification of the user NK in the form of an association with a specific group (for example a group of standard users or advanced users) is possible using these stored data. By using this classification, the user interface can be better adapted to f iu rer users of the same or a similar group by taking into account the information.

FIG. 4 shows an inventive device 1 for use in the optimization of the implementation of measurements. Measurements are hereby conducted in different medical facilities 2 (which are clinics and research facilities in different countries) by different users 3 with the aid of imaging medical examination apparatuses 4 of different types that here should be indicated by the different geometric shapes.

For this, a user interface 5 for selection and input of measurement-related information is respectively available to the users 3. The items of measurement-related information that the users 3 input via the user interface 5 are transferred via a network 6 (indicated here by arrows) to a storage device 7 with a centralized or decentralized organization. Furthermore, information identifying the user 3 executing the measurement is transferred to the storage device 7. Dependent on this information identifying the users 3, a linking of the items of measurement-related information finally occurs under consideration of at least one determined item of measurement parameter information, which linking is implemented by the data processing system (not specifically shown here) with the network 6 and the storage device 7.

Under recourse to adaptable and knowledge-based systems of a databank present in the storage device 7, a user-specific adaptation of the user interface 5 finally ensues dependent on the link results for the respective measurements by the users 3 at the imaging medical examination apparatuses 4. The adaptation of the user interface 5 is indicated hereby the arrow of the network 6 leading back to the respective medical apparatuses 2. According to the invention, an optimization of the workflow in the implementation of measurements is thus possible, in particular using protocols, since the user interface is clearly designed with input and selection possibilities for measurement-related information that correspond to the actual requirements of the respective user 3.

Although other modifications and changes may be suggested by those skilled in the art, it is the intention of the inventors to embody within the patent warranted hereon all changes and modifications as reasonably and properly come within the scope of their contribution to the art.

We claim:

1. A method for optimizing an implementation of measurements with at least one imaging medical examination apparatus, comprising the followings steps:
determining a first item of measurement-related information, said first item of measurement-related information being in a form of an employed item of measurement parameter information in a measurement executed by a user using a program-based measurement;
determining a second item of measurement-related information established by the user;
storing said first and second items of measurement-related information in a storage device via a data processing system;
determining at least one item of information identifying the user executing the measurement and storage of said items of information with the measurement-related information in the storage device;
linking the measurement parameter information and at least one further item of measurement-related information dependent on the information identifying the user, said linking step being performed via the data processing system; and
adapting a user interface for operation of the program-based measurement to provide a user-specific adaptation of the user interface dependent on a result of the linking step.

2. A method according to claim 1, wherein said further item of measurement-related information is at least one of further measurement parameter information and processing information regarding data of the measurement.

3. A method according to claim 1, further comprising the step of:
adapting at least one protocol selected by the user via the user interface dependent on a result of said linking step.

4. A method as claimed in claim 3, wherein said at least one protocol is at least one of a measurement protocol and a processing protocol.

5. A method as claimed in claim 1, further comprising the step of:
executing at least one protocol selected by the user via the user interface dependent on a result of said linking step.

6. A method as claimed in claim 5, wherein said at least one protocol is at least one of a measurement protocol and a processing protocol.

7. A method according to claim 1, further comprising the step of:
determining at least one item of measurement parameter information and further measurement-related information in a further measurements, said measurement parameter information and further measurement-related information being linked with the measurement-related information of a first measurement for adaptation of the user interface.

8. A method as claimed in claim 7, wherein said step of determining at least one item of measurement parameter information and further measurement-related information is determined in a framework of a follow-up examination.

9. A method according to claim 1, further comprising the step of:
linking said further measurement-related information with one another to adapt the user interface.

10. A method as claimed in claim 1, further comprising the step of:
linking said further measurement-related information with protocols to adapt the user interface.

11. A method as claimed in claim 10, wherein said protocols are one of measurement protocols and processing protocols.

12. A method according to claim 1, wherein said user interface is adapted by specifying at least one of measurement parameter information and further measurement-related information.

13. A method according to claim 12, further comprising the step of:
using the specified information in a subsequent measurement.

14. A method as claimed in claim 13, wherein said subsequent measurement is one of after determination of at least one overview image and repetition of a measurement.

15. A method according to claim 1, further comprising the step of:
adapting the user interface by changing a hierarchy for at least one of selection and input of protocols.

16. A method according to claim 1, further comprising the step of:
adapting the user interface by changing a hierarchy for at least one of selection and input of measurement parameter information.

17. A method according to claim 1, further comprising the step of:
adapting. the user interface by changing, a hierarchy for at least one of selection and limiting of protocols.

18. A method according, to claim 1, further comprising the step of:
adapting the user interface by changing a hierarchy for at least one of selection and limiting of measurement parameter information.

19. A method according to claim 1, further comprising, the step of:
displaying measurement-related information regarding at least one of selection and change by a user organized in a framework of an adaptation of the user interface.

20. A method according to claim 1, further comprising the step of:
storing at least one of the measurement parameter information and the further measurement-related information and the link result in a databank.

21. A method according to claim 20, further comprising the step of:
linking at least one new item of measurement-related information stored in the databank with at least one already-present item of measurement-related information.

22. A method as claimed in claim 20, further comprising the step of:
linking at least one new item of measurement-related information with further data of the databank.

23. A method according to claim 1, further comprising the step of:
determining probabilities on a part of the data processing system for stored measurement-related information and link results.

24. A method according to claim 1, further comprising the step of:
checking plausibility on a part of the data processing system for stored measurement-related information and link results.

25. A method according to claim 1, further comprising the step of:
associating the user with a class of users depending on at least one of measurement-related information and link results.

26. A method according to claim 1, further comprising the step of:
storing measurement-related information of at least one of a user and a class of users in a data field.

27. A method according to claim 1, further comprising the step of:
storing measurement-related information in a file that is adapted given changes by the user.

28. A method as claimed in claim 27, wherein said measurement-related information stored in said storing step is measurement parameter information.

29. A method according to claim 1, further comprising the step of
using at least one of an adaptive learning-capable system and a knowledge-based system for adaptation of the user interface.

30. A method according to claim 1, further comprising the step of:
exchanging data using the data processing system with at least one existing information system.

31. A method as claimed in claim 30, wherein said at least one existing information system includes an information system of one of a medical facility and a class of users.

32. A method according to claim 1, further comprising the step of:
enabling user definition of determination of one of measurement information and link results and specification of measurement information.

33. A device for optimization of implementation of measurements with imaging medical examination apparatus, comprising:
a data processing system including a storage device connected to the imaging medical examination apparatus;
a user interface for display of a program-based measurement means, the user interface being adapted specific to a user according to the following steps:
determining a first item of measurement-related information, said first item of measurement-related information being in a form of an employed item of measurement parameter information in a measurement executed by a user using a program-based measurement;
determining a second item of measurement-related information established by the user;
storing said first and second items of measurement-related information in a storage device via a data processing system;
determining at least one item of information identifying the user executing the measurement and storage of said items of information with the measurement-related information in the storage device;
linking the measurement parameter information and at least one further item of measurement-related information dependent on the information identifying the user, said linking step being performed via the data processing system; and
adapting a user interface for operation of the program-based measurement to provide a user-specific adaptation of the user interface dependent on a result of the linking step.
